(19) United States
(12) Patent Application Publication
(10) Pub. No.: US 2015/0131340 A1
(43) Pub. Date: May 14, 2015

(54) POWER SUPPLY DEVICE

(71) Applicant: SAMSUNG ELECTRO-MECHANICS CO., LTD., Suwon-Si (KR)

(72) Inventors: Tae Won Heo, Suwon-Si (KR); Erlan Dzunusbekov, Suwon-Si (KR); Dmitry Berdnikov, Suwon-Si (KR)

(73) Assignee: SAMSUNG ELECTRO-MECHANICS CO., LTD., Suwon-Si (KR)

(21) Appl. No.: 14/476,711

(22) Filed: Sep. 3, 2014

(30) Foreign Application Priority Data
Nov. 8, 2013 (KR) 10-2013-0135416

(51) Int. Cl. H02M 3/335; H02M 1/08

(52) U.S. Cl. CPC H02M 3/33507; H02M 1/08; H02M 2001/0006
USPC 363/21.12

(57) ABSTRACT

A power supply device may include a transformer having a primary winding receiving a rectified alternating current (AC) input power and a secondary winding electromagnetically coupled to the primary winding to supply power to a load, an auxiliary switch selectively providing the rectified AC input power to the primary winding, and a limitation controlling unit controlling the auxiliary switch based on a voltage level of the AC input power.

### CROSS-REFERENCE TO RELATED APPLICATION

This application claims the benefit of Korean Patent Application No. 10-2013-0135416 filed on Nov. 8, 2013, with the Korean Intellectual Property Office, the disclosure of which is incorporated in its entirety herein by reference.

### BACKGROUND

The present disclosure generally relates to a power supply device capable of limiting or controlling a supply of power, depending on variations in an input voltage.

A general off-line power supply device may be operated so that abnormality does not occur in an output voltage, generated in respect to an input voltage, having a range of, for example, but not limited to, 90 Vac to 264 Vac.

In the case of a flyback converter, in such a wide input range, a duty variation width with respect to input variations is wide. Since the input range is wide, in the case in which the input voltage is a maximum or high voltage, 264 Vac, a peak voltage may be relatively high, such that a voltage of Vin=\sqrt{2}×264=373.3[Vpeak] is applied to a bulk capacitor when an alternating current (AC) input is rectified. Therefore, a high voltage may be also applied to a switching element on a primary side and a rectifying diode on a secondary side due to a relational expression of a turns ratio (n).

Therefore, components having a high withstand voltage may be used. For example, an element having a withstand voltage of 420V may be used as the bulk capacitor, and an element having a withstand voltage of 650V may be used as the switching element on the primary side.

Particularly, in the case of an LLC resonant half-bridge converter that has been commonly used in recent times, in the case in which a range of variations in an input voltage is wide, a frequency variation width and a gain variation width may be very wide. Therefore, it may be difficult to design a resonance tank, such that an optimal operation of an LLC resonant half-bridge converter may not be ensured. In this case, an LLC resonant half-bridge converter may be used after a power factor correction (PFC) pre-regulator is used to render the input voltage constant.

Therefore, there is a need for an efficient method of limiting or controlling variations in an input link voltage.

### SUMMARY

An exemplary embodiment in the present disclosure may provide a power supply device capable of limiting or controlling variations in an input link voltage.

An exemplary embodiment in the present disclosure may also provide a power supply device provided with a bulk capacitor having a low withstand voltage.

An exemplary embodiment in the present disclosure may also provide a power supply device provided with a power transferring switch and a rectifying diode that have a low withstand voltage.

According to an exemplary embodiment in the present disclosure, a power supply device may include: a transformer having a primary winding receiving an input power and a secondary winding electromagnetically coupled to the primary winding to supply power to a load; an auxiliary switch selectively providing, or switching transfer of, the input power to the primary winding; and a limitation controlling unit controlling the auxiliary switch based on a voltage level of the input power.

The auxiliary switch may comprise at least one of an insulated gate bipolar transistor (IGBT), a metal oxide semiconductor field effect transistor (MOSFET), or a bipolar junction transistor (BJT).

The limitation controlling unit may turn the auxiliary switch off in the case in which the voltage level of the input power exceeds a limit or predetermined level.

The limitation controlling unit may turn the auxiliary switch on in the case in which the voltage level of the input power is less than the limit or predetermined level.

The power supply device may further include an input power unit providing alternating current (AC) power as the input power.

The power supply device may further include a rectifying unit rectifying the AC power from the input power unit.

The power supply device may further include a smoothing capacitor smoothing the AC power rectified by the rectifying unit.

The limitation controlling unit may control the auxiliary switch based on a voltage level of the AC power and/or a withstand voltage of the smoothing capacitor.

The limitation controlling unit may turn the auxiliary switch off in the case in which the voltage level of the AC power exceeds the withstand voltage of the smoothing capacitor.

The limitation controlling unit may turn the auxiliary switch on in the case in which the voltage level of the AC power is less than the withstand voltage of the smoothing capacitor.

According to an exemplary embodiment in the present disclosure, a power supply device may include: an input power unit providing AC power; a rectifying unit rectifying the AC power; a transformer having a primary winding receiving the rectified AC power and a secondary winding electromagnetically coupled to the primary winding to supply power to a load; an auxiliary switch selectively providing, or switching transfer of, the rectified AC power to the primary winding; an input voltage detecting unit obtaining a voltage level of the AC power; and a limitation controlling unit controlling the auxiliary switch based on the voltage level of the AC power.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating a configuration of an exemplary embodiment of a flyback converter not having an auxiliary switch;

FIG. 2 is a view illustrating a configuration of a flyback converter according to an exemplary embodiment in the present disclosure;

FIG. 3 is a view illustrating a circuit configuration of the flyback converter according to an exemplary embodiment in the present disclosure;

FIG. 4 is a view illustrating waveforms of an output voltage Vout, a bulk voltage Vcap, and a full-wave rectified power Vin_rec of the flyback converter that does not include an auxiliary switch;

FIG. 5 is a view illustrating waveforms of an output voltage Vout, a bulk voltage Vcap, a full-wave rectified power Vin_rec, and a gate signal Q10 of the flyback converter according to an exemplary embodiment in the present disclosure in the case in which an input voltage is 90 Vac;

FIG. 6 is a view illustrating waveforms of an output voltage Vout, a bulk voltage Vcap, a full-wave rectified power Vin_rec, and a gate signal Q10 of the flyback converter according to an exemplary embodiment in the present disclosure in the case in which an input voltage is 115 Vac;

FIG. 7 is a view illustrating waveforms of an output voltage Vout, a bulk voltage Vcap, a full-wave rectified power Vin_rec, and a gate signal Q10 of the flyback converter according to an exemplary embodiment of the present disclosure in the case in which an input voltage is 230Vac; and

FIG. 8 is a view illustrating waveforms of an output voltage Vout, a bulk voltage Vcap, a full-wave rectified power Vin_rec, and a gate signal Q10 of the flyback converter according to an exemplary embodiment of the present disclosure in the case in which an input voltage is 264 Vac.

### DETAILED DESCRIPTION

Hereinafter, embodiments in the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

For convenience of explanation, a configuration for limiting variations in an input link voltage based on a flyback converter will be described in the present specification.

However, it may be readily understood by those skilled in the art that a configuration according to an exemplary embodiment described in the present specification may also be applied to a forward converter, a half-bridge converter, a full-bridge converter, and the like.

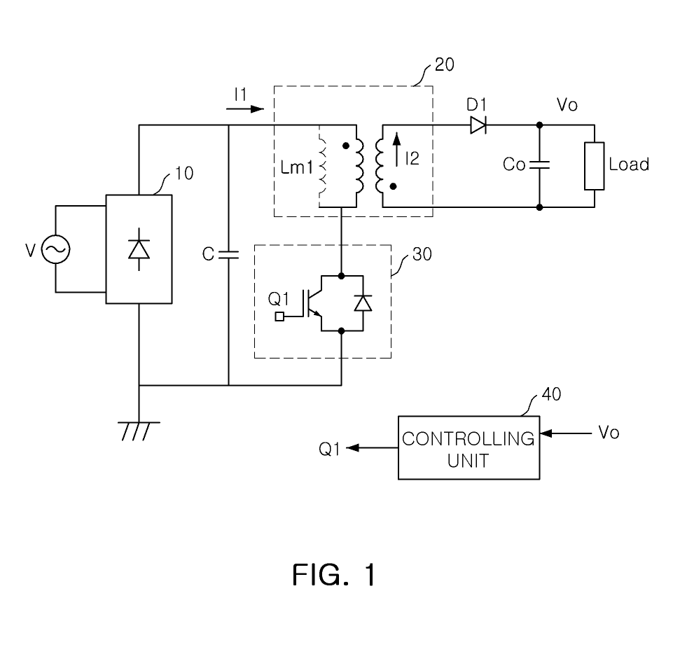

FIG. 1 is a view illustrating a configuration of an exemplary embodiment of a flyback converter not having an auxiliary switch.

Referring to FIG. 1, the flyback converter may include a input power unit V, a transformer 20, a rectifying unit 10, a smoothing capacitor C, a switching element 30, a controlling unit 40, and a rectifying diode D1. An Lm1 of FIG. 1 may refer a mutual inductance of the transformer 20.

The input power unit V may supply an input power. The input power may be AC power, but not limited thereto.

The rectifying unit 10 may receive the AC power from the input power unit V, rectify the received power, and transfer the rectified power to the transformer 20.

The smoothing capacitor C may stabilize the power output through the rectifying unit 10.

The transformer 20 may transform a primary current I1 from the input power unit V into a secondary current I2.

The switching element 30 may intermit the primary current I1 flowing in a primary winding of the transformer 20.

The switching element 30 according to an exemplary embodiment of the present disclosure may be formed of or comprise at least one of an insulated gate bipolar transistor (IGBT), a metal oxide semiconductor field effect transistor (MOSFET), and a bipolar junction transistor (BJT).

The rectifying diode D1 may rectify the secondary current I2 of the transformer 20.

A capacitor element C₀ may stabilize power transferred from the rectifying diode D1.

The controlling unit 40 may obtain information of output voltage Vo.

The controlling unit 40 may apply or generate a driving signal Q1 for driving the switching element 30 based on the information of the output voltage Vo.

The controlling unit 40 may perform a constant voltage output control.

In order for the flyback converter to transfer energy on a primary side of the transformer 20 to a secondary side of the transformer 20, the switching element 30 may perform a switching operation.

In the case in which the voltage of the input power is a maximum or high input voltage, 264 Vac, a peak voltage may be high, such that a voltage of Vin=\sqrt{2}×264=373.3[Vpeak] may be applied to the smoothing capacitor C when the input power is rectified. Therefore, a high voltage may also be applied to the switching element 30 on the primary side and the rectifying diode D1 on the secondary side from a relational expression of a turns ratio of the transformer 20.

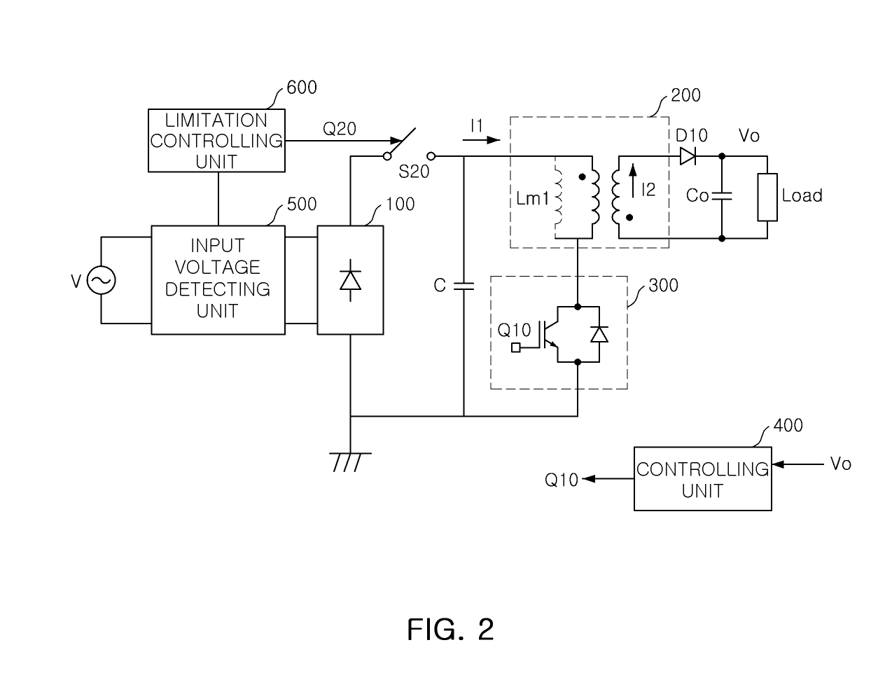

FIG. 2 is a view illustrating a configuration of a flyback converter according to an exemplary embodiment in the present disclosure.

Referring to FIG. 2, the flyback converter according to an exemplary embodiment of the present disclosure may include a input power unit V, a transformer 200, a rectifying unit 100, a smoothing capacitor C, a switching element 300, a controlling unit 400, a rectifying diode D10, an input voltage detecting unit 500, a limitation controlling unit 600, and an auxiliary switch S20. An Lm1 of FIG. 2 may refer a mutual inductance of the transformer 200.

Some exemplary descriptions of the input power unit V, the transformer 200, the rectifying unit 100, the smoothing capacitor C, the switching element 300, the controlling unit 400, and the rectifying diode D10 have been provided with reference to FIG. 1. Therefore, components other than the above-mentioned components will be described below in detail.

The input power unit V may supply an input power. The input power may be AC power, but not limited thereto.

The rectifying unit 100 may receive the AC power, rectify the received power, and transfer the rectified power to the transformer 200.

The smoothing capacitor C may stabilize the power output through the rectifying unit 100.

The transformer 200 may have a primary winding receiving the rectified AC input power and a secondary winding electromagnetically coupled to the primary winding to supply power to a load.

The auxiliary switch S20 may switch the transfer of the rectified AC power to the primary winding of the transformer 200.

The auxiliary switch S20 according to an exemplary embodiment of the present disclosure may be formed of or comprise at least one of an IGBT, a MOSFET, and a BJT.

The input voltage detecting unit 500 may obtain a voltage level of the AC input power. In addition, the input voltage detecting unit 500 may output the voltage level of the AC input power to the limitation controlling unit 600.

The limitation controlling unit 600 may control the auxiliary switch S20 based on the voltage level of the AC input power by applying a driving signal Q20 to the auxiliary switch S2.

For example, the limitation controlling unit 600 may turn the auxiliary switch S20 off in the case in which the voltage level of the AC input power exceeds a predetermined level. The limitation controlling unit 600 may turn the auxiliary switch S20 on in the case in which the voltage level of the AC input power is less than the predetermined level.

The predetermined level may be determined in consideration of, for instance, but not limited to, a withstand voltage of the smoothing capacitor C. The predetermined level may have an upper limit of an input link voltage.

The limitation controlling unit 600 may control the auxiliary switch S20 based on the voltage level of the AC input power and/or the withstand voltage of the smoothing capacitor C.

For example, the limitation controlling unit 600 may turn the auxiliary switch S20 off in the case in which the voltage level of the AC input power exceeds the withstand voltage of the smoothing capacitor C. The limitation controlling unit 600 may turn the auxiliary switch S20 on in the case in which the voltage level of the AC input power is less than the withstand voltage of the smoothing capacitor C. Additionally, the limitation controlling unit 600 may turn the auxiliary switch S20 off in the case in which the voltage level of the AC input power exceeds a preset voltage of the smoothing capacitor C. The limitation controlling unit 600 may turn the auxiliary switch S20 on in the case in which the voltage level of the AC input power is less than the preset voltage of the smoothing capacitor C.

Referring to FIG. 2, the auxiliary switch S20 may connect between the rectifying unit 100 and the smoothing capacitor C. In addition, the auxiliary switch S20 may be turned on/off based on the voltage level of the AC input power and/or the preset voltage level.

That is, the auxiliary switch S20 may be synchronized with a line frequency to perform a turn-on operation when an input voltage becomes lower than a set voltage.

For example, in the case in which the set voltage is 300V and an input voltage of 100 Vac is applied, Vin_peak=1.414*100=141.4V, lower than the set voltage (300V), such that the auxiliary switch S20 may be maintained in a turned-on state throughout an entire range of an input frequency.

In the case in which the set voltage is 300V and an input voltage of 230 Vac is applied, Vin_peak=325V, such that the auxiliary switch S20 may be turned off.

Therefore, a bulk voltage may not exceed 300Vdc in a condition of an entire input range.

Therefore, in the power supply device according to an exemplary embodiment of the present disclosure, a bulk capacitor having a low withstand voltage may be used. In addition, a size of the power supply device may be decreased.

Furthermore, components having a low withstand voltage may be used as the switching element 300 and the rectifying diode D10 connected to the secondary winding.

In addition, in the case in which a synchronous rectifier MOSFET is used instead of the rectifying diode D10 connected to the secondary wirding, a MOSFET having a low withstand voltage maybe used, a voltage drop may be decreased, and a component may be miniaturized.

Further, since an operation range of the transformer 200 becomes narrow, the power supply device may be easily designed.

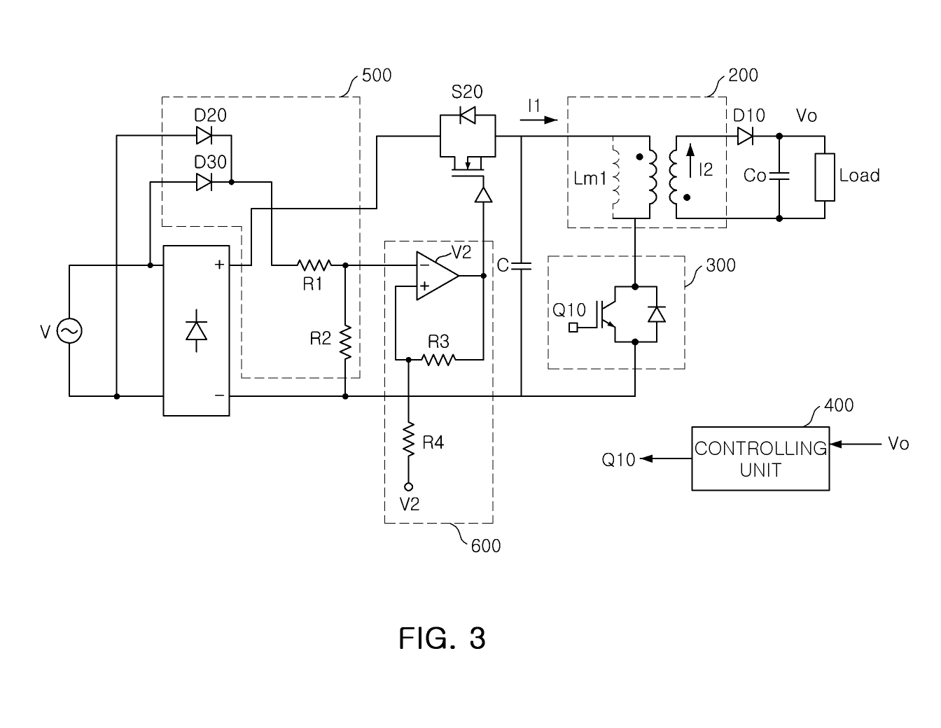

FIG. 3 is a view illustrating a circuit configuration of the flyback converter according to an exemplary embodiment in the present disclosure.

Referring to FIG. 3, the input voltage detecting unit 500 may be configured by a combination of diode elements D20 and D30 and resistor elements R1 and R2.

In addition, the limitation controlling unit 600 may be configured by a combination of a comparison voltage source V2 and resistor elements R3 and R4.

However, the above-mentioned circuit configuration is an example of a circuit diagram in the present disclosure that is embodied, and may be variously changed by those skilled in the art, if necessary.

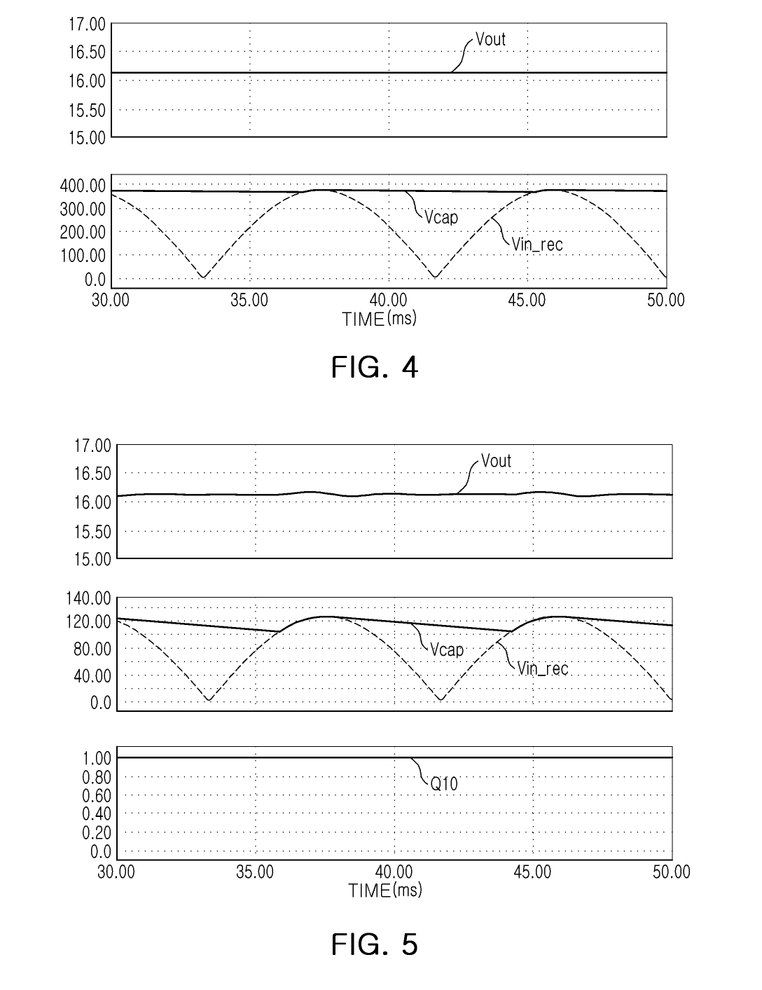

FIG. 4 is a view illustrating waveforms of an output voltage Vout, a bulk voltage Vcap, and a full-wave rectified power Vin_rec of the exemplary embodiment of the flyback converter that does not include an auxiliary switch in the case in which an input voltage is 264 Vac.

FIG. 5 is a view illustrating waveforms of an output voltage Vout, a bulk voltage Vcap, a full-wave rectified power Vin_rec, and a gate signal Q10 of the flyback converter according to an exemplary embodiment in the present disclosure in the case in which an input voltage is 90 Vac.

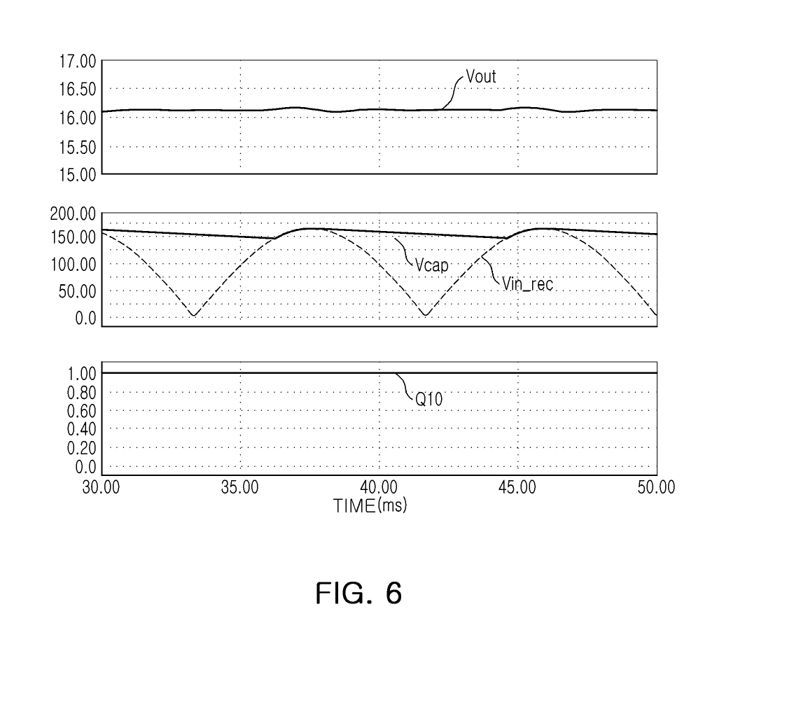

FIG. 6 is a view illustrating waveforms of an output voltage Vout, a bulk voltage Vcap, a full-wave rectified power Vin_rec, and a gate signal Q10 of the flyback converter according to an exemplary embodiment of the present disclosure in the case in which an input voltage is 115 Vac.

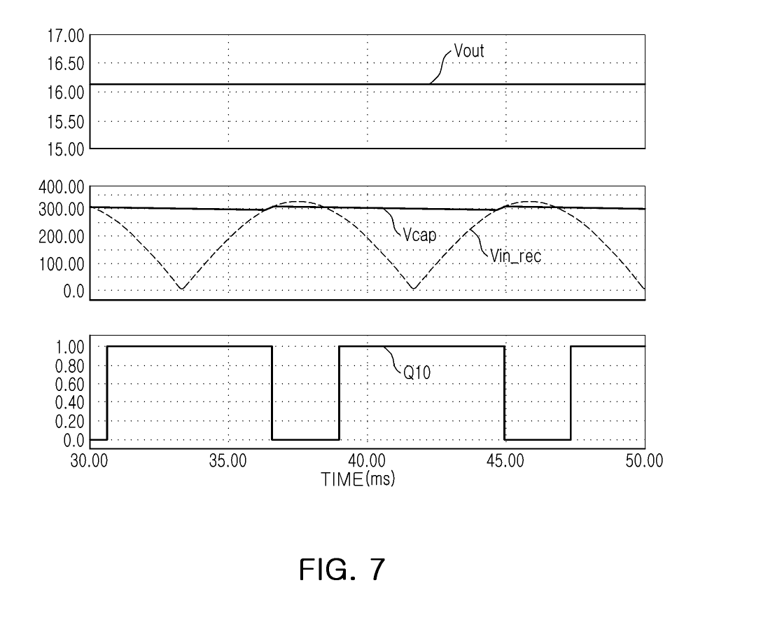

FIG. 7 is a view illustrating waveforms of an output voltage Vout, a bulk voltage Vcap, a full-wave rectified power Vin_rec, and a gate signal Q10 of the flyback converter according to an exemplary embodiment in the present disclosure in the case in which an input voltage is 230 Vac.

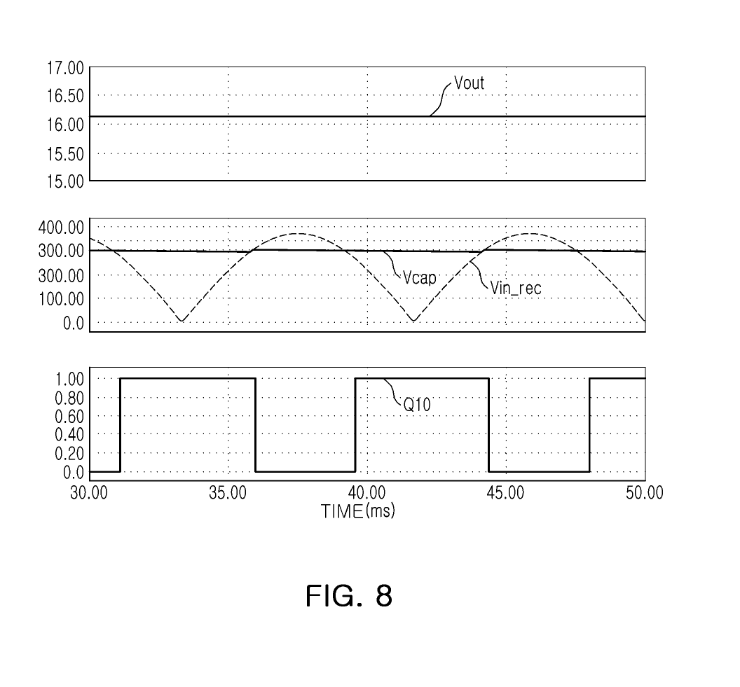

FIG. 8 is a view illustrating waveforms of an output voltage Vout, a bulk voltage Vcap, a full-wave rectified power Vin_rec, and a gate signal Q10 of the flyback converter according to an exemplary embodiment in the present disclosure in the case in which an input voltage is 264 Vac.

Referring to FIG. 4, it maybe confirmed that a voltage of the bulk capacitor is 373.3V.

Referring to FIGS. 5 and 6, it may be confirmed that an input voltage is a set voltage (300V) or less, such that the auxiliary switch is maintained in a turned-on state and a voltage of the bulk capacitor is lower than 141.4V.

Referring to FIGS. 7 and 8, it may be confirmed that in the case in which an input voltage is 230 Vac, a peak voltage is 325V, or in the case in which an input voltage is 264 Vac, a peak voltage is 373V, the auxiliary switch S20 is turned off in a section in which the input voltage is a set voltage (300V) or more, and a voltage of the bulk capacitor is limited so as to be less than 300V.

The power supply device according to an exemplary embodiment of the present disclosure having the configuration as described above may limit variations in an input link voltage.

In addition, the power supply device may use a bulk capacitor having a low withstand voltage.

Further, the power supply device may use a power transferring switch and a rectifying diode having a low withstand voltage.

While exemplary embodiments have been shown and described above, it will be apparent to those skilled in the art that modifications and variations could be made without departing from the spirit and scope of the present disclosure as defined by the appended claims.

What is claimed is:

1. A power supply device comprising:
a transformer having a primary winding to receive an input power and a secondary winding electromagnetically coupled to the primary winding to supply power to a load;
an auxiliary switch configured to selectively provide the input power to the primary winding; and
a limitation controlling unit configured to control the auxiliary switch based on a voltage level of the input power.

2. The power supply device of claim 1, wherein the auxiliary switch comprises at least one of an insulated gate bipolar transistor (IGBT), a metal oxide semiconductor field effect transistor (MOSFET), or a bipolar junction transistor (BJT).

3. The power supply device of claim 1, wherein the limitation controlling unit turns off the auxiliary switch in the case in which the voltage level of the input power exceeds a predetermined level.

4. The power supply device of claim 3, wherein the limitation controlling unit turns on the auxiliary switch in the case in which the voltage level of the input power is less than the predetermined level.

5. The power supply device of claim 1, further comprising an input power unit providing alternating current (AC) power as the input power.

6. The power supply device of claim 5, further comprising a rectifying unit rectifying the AC power from the input power unit.

7. The power supply device of claim 6, further comprising a capacitor smoothing the AC power rectified by the rectifying unit.

8. The power supply device of claim 7, wherein the limitation controlling unit controls the auxiliary switch based on a voltage level of the AC power and/or a withstand voltage of the capacitor.

9. The power supply device of claim 8, wherein the limitation controlling unit turns off the auxiliary switch in the case in which the voltage level of the AC power exceeds the withstand voltage of the capacitor.

10. The power supply device of claim 8, wherein the limitation controlling unit turns on the auxiliary switch in the case in which the voltage level of the AC power is less than the withstand voltage of the capacitor.

11. A power supply device comprising:
an input power unit providing AC power;
a rectifying unit rectifying the AC power;
a transformer having a primary winding to receive the rectified AC power and a secondary winding electromagnetically coupled to the primary winding to supply power to a load;
an auxiliary switch configured to selectively provide the rectified AC power to the primary winding;
an input voltage detecting unit configured to detect a voltage level of the AC power; and
a limitation controlling unit configured to control the auxiliary switch based on the voltage level of the AC power.

12. The power supply device of claim 11, wherein the auxiliary switch comprises at least one of an IGBT, a MOSFET, or a BJT.

13. The power supply device of claim 11, wherein the limitation controlling unit turns off the auxiliary switch in the case in which the voltage level of the AC power exceeds a predetermined level.

14. The power supply device of claim 13, wherein the limitation controlling unit turns on the auxiliary switch in the case in which the voltage level of the AC power is less than the predetermined level.

15. The power supply device of claim 14, further comprising a capacitor smoothing the AC power rectified by the rectifying unit.

16. The power supply device of claim 15, wherein the limitation controlling unit controls the auxiliary switch based on the voltage level of the AC power and a withstand voltage of the capacitor.

17. The power supply device of claim 16, wherein the limitation controlling unit turns off the auxiliary switch in the case in which the voltage level of the AC power exceeds the withstand voltage of the capacitor.

18. The power supply device of claim 16, wherein the limitation controlling unit turns on the auxiliary switch in the case in which the voltage level of the AC power is less than the withstand voltage of the capacitor.
